(19) United States
(12) Patent Application Publication
(10) Pub. No.: US 2021/0083889 A1
(43) Pub. Date: Mar. 18, 2021

(54) EFFICIENT MEETING MANAGEMENT

(71) Applicant: INTERNATIONAL BUSINESS MACHINES CORPORATION, Armonk, NY (US)

(72) Inventors: Al Chakra, Apex, NC (US); Ahmad Abdul Wakeel, Dublin (IE); FAISAL GHAFFAR, Meath (IE); KEVIN CARR, RALEIGH, NC (US)

(21) Appl. No.: 16/574,194

(22) Filed: Sep. 18, 2019

(51) Int. Cl. H04L 12/18; H04L 29/08; G06Q 50/00

(52) U.S. Cl. CPC H04L 12/1822; G06Q 50/01; H04L 67/22; H04L 12/1818

(57) ABSTRACT

Aspects of the invention include efficient meeting management A non-limiting example of a computer-implemented method includes profiling, by a processor, a first trait of a first participant and a second trait of a second participant and determining, by the processor, a first sociability score of the first participant and a second sociability score of the second participant. The computer-implemented method profiles, by the processor, a first skill set of the first participant and a second skill set of the second participant and calculates, by the processor, participation scores of the first participant and the second participant based on the traits, sociability scores, and skill sets of the first participant and the second participant. The computer-implemented method allocates, by the processor, time to the first participant and the second participant based on the respective participation scores of the first participant and the second participant.

### BACKGROUND

The present invention generally relates to meetings, and more specifically, to efficient meeting management

In online meetings, some participants may be passive and others dominating. Some are more open and willing to share information than others. Meeting participants can provide varying levels of input considering their skill set in relation to the meeting agenda. It is goal of the moderator to create an environment where everyone has an opportunity to contribute to a discussion in a given context and that often means installing some controls.

### SUMMARY

Embodiments of the present invention are directed to efficient meeting management. A non-limiting example of a computer-implemented method includes profiling, by a processor, a first trait of a first participant and a second trait of a second participant and determining, by the processor, a first sociability score of the first participant and a second sociability score of the second participant. The computer-implemented method profiles, by the processor, a first skill set of the first participant and a second skill set of the second participant and calculates, by the processor, participation scores of the first participant and the second participant based on the traits, sociability scores, and skill sets of the first participant and the second participant. The computer-implemented method allocates, by the processor, time to the first participant and the second participant based on the respective participation scores of the first participant and the second participant.

Other embodiments of the present invention implement features of the above-described method in computer systems and computer program products. The computer systems and computer program products profile a first trait of a first participant and a second trait of a second participant and determine a first sociability score of the first participant and a second sociability score of the second participant. The computer systems and computer-program products profile a first skill set of the first participant and a second skill set of the second participant and calculate participation scores of the first participant and the second participant based on the traits, sociability scores, and skill sets of the first participant and the second participant. The computer system and computer program product allocate time to the first participant and the second participant based on the respective participation scores of the first participant and the second participant.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a flow diagram of a process for allocating meeting time in accordance with one or more embodiments of the present invention;

FIG. 2 depicts a cloud computing environment according to one or more embodiments of the present invention;

FIG. 3 depicts abstraction model layers according to one or more embodiments of the present invention; and

FIG. 4 depicts a computer system in accordance with an embodiment of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

A system and method that consider are provided to assist a moderator in identifying participants that will be requested to participate in a meeting. One or more embodiments of the present invention may be utilized to reduce the speaking time of dominant participants, while also being flexible enough to allow a dominating participant to contribute based on a current context of the meeting. This helps in utilizing meeting time efficiently by utilizing participants' skill sets in a better way while reducing factors such as filibusters.

One or more embodiments of the present invention provide a ranked list of meeting participants who should contribute to a topic. Furthermore, a time duration can be determined and assigned to each of the meeting participants to determine how long a participant can speak. The system and method assist moderators of a meeting in choosing who among meeting participants should contribute to a meeting and for how long.

Participants, depending upon personality, may be either reluctant to contribute to a meeting or filibuster a meeting. By analyzing the traits of meeting participants, determining a sociability score, and profiling their skill sets, a participation score can be determined and used to assign time slots to participants. This reduces filibusters from participants who may not have highly relevant skill sets, while increasing participation from reluctant participants who may have more relevant skill sets. Leveraging the computational power of computing resources, the method can fulfill the worthwhile goal of making meetings more efficient.

One or more embodiments of the present invention provide technological improvements over current methods of meeting management that requires a moderator guess what skills participants possess and work without knowledge of participant personalities. Disadvantages of contemporary approaches may include filibustering of meetings by unskilled participants and silence from valuable potential contributors. One or more embodiments of the present invention provide technical solutions to one or more of these disadvantages of existing solutions by providing calculations of time durations of participants' access to an online meeting and automatically assigning time slots to various participants based on their personality and ability to contribute.

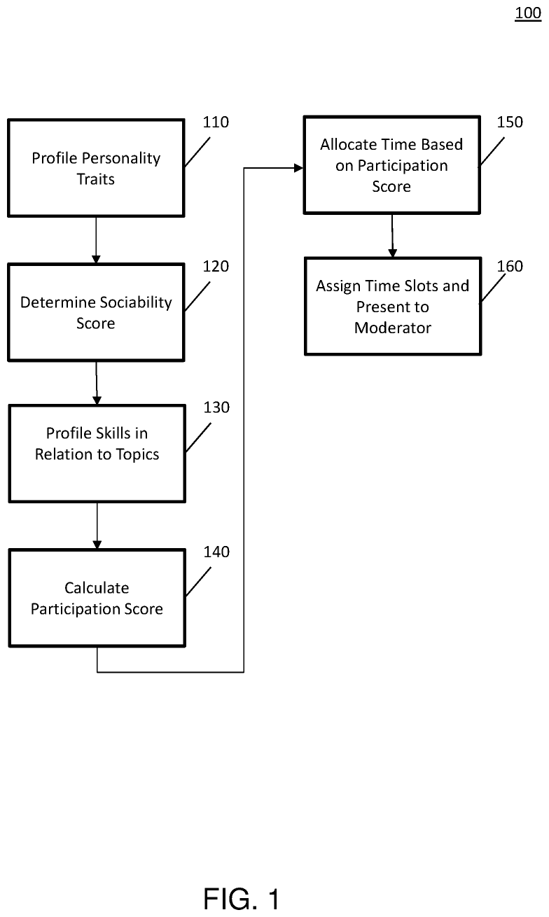

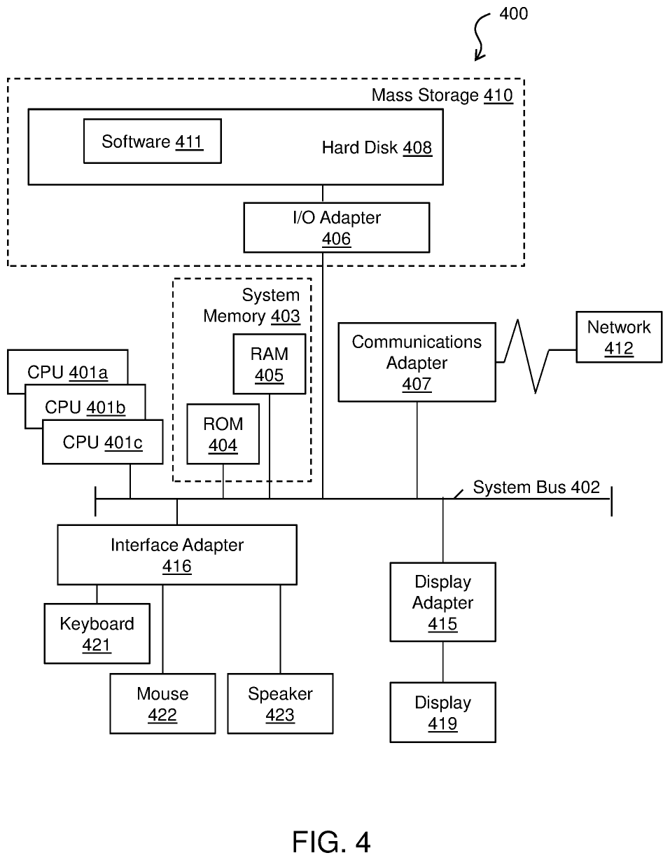

Turning now to FIG. 1, flow diagram of a process 100 for allocating meeting time in accordance with one or more embodiments of the present invention is illustrated. Reference will be made to processor 401 found in, and later described with respect to, FIG. 4. A meeting participant's personality is profiled by processor 401 (Block 110). In an exemplary embodiment, five traits are profiled: agreeableness, extraversion, conscientiousness, neuroticism, and openness. This is performed, for example, through a questionnaire, such as the International Personality Item Pool (“IPIP”), as described by Goldberg in 2007 and found at https://ipip.ori.org. Using IPIP, let α_{personality} be the aggregated personality score of the meeting participants calculated by processor 401 such that α_{personality}=∫β₁*Extraversion+β₂*Agreeableness+β₃*Conscientiousness+β₄*Neuroticism+β₅*Openness, where βₙ is the relative weights of the specific variable (i.e. the strength of the predictor). The traits, weights, and final result can be stored for each participant in mass storage 410, which may include a suitable database.

Sociability scores are determined by processor 401 (Block 120), which indicates their willingness to share and cooperate with others. Here, any tool can be used to score the participants from their social networks and/or their collaboration activities with a participant's permission. Klout™ is an example of a tool which scored users of a social networking service based on their activity and reaction on their posts or influence on others. Other tools include Social Mention™, Empire.Kred™, Twitter Counter™ Hootsuite Insights™ and BuzzSumo™. Let α_{social} be a parameter which defines sociability score of a meeting participant. The sociability score, α_{social}, is stored in mass storage 410 or a suitable database.

Skills are profiled in relation to topics selected for the online meeting by processor 401 (Block 130). Any suitable profiling tool can be used. For example, European e-Competence Framework (e-CF), at http://www.ecompetences.eu, is one such tool. This framework identifies 36 competences, readable and understandable across different countries in Europe. The method can parse participants' resumes to consider experience and qualifications on certain topics. It can attribute skill-proficiency levels to each of a set of topics in a topic pool. e.g. expert in java programming, intermediate in java script, expert in performance engineering, intermediate in database, for example. The skill profiles are stored in mass storage 410 or a suitable database.

A participation score is calculated by processor 401 (Block 140). A regression analysis is used, in one exemplary embodiment, which considers the personality measurements, skill profiles, and sociability scores to give a participation score.

Participation=∫α1β1+α2β2+α3β3+ . . . +αnβn+ε, where:

α1=personality measurement (∫β1*Extraversion+β2*Agreeableness+β3*Conscientiousness+β4*Neuroticism+β5*Openness)

α2=Sociability/intent to share measurement

α3=competency/skills related measurements

αn=any additional measurement

The β's represent the relative weights of the specific variable in the equation, ie the strength of the predictor. If for instance α3, competency measurement, is a strong predictor of the participation level, stronger than α1, the personality measurement, β3 would be larger than β1.

The method allocates time, by processor 401, based on the participation score determined above (Block 150). Initially, the amount of time is divided into equal parts for all participants. The time is then adjusted based on the participation score. This is done, for example, using Myerson's allocation rule, also known as Meyerson's Lemma. The end result is presented to the moderator in a table, so that the moderation can use the table to allocate time to each individual based on their participation score (Block 160). Or, the end result is used by processor 401 to automatically engage with particular participants during an allocated time period. For example, the following table may be provided based on participation scores:

| Participant | Participation Score | Rank | Time Slot (minutes) |
|---|---|---|---|
| John | 0.7 | 3 | 5 |
| Alice | 1.7 | 1 | 11 |
| Bob | 0.9 | 2 | 6 |
| Kelly | 0.3 | 4 | 2 |
| Sean | 0.1 | 5 | 1 |

While the table may simply be provided to the moderator in order to run the conference, the information in the table may also be used by processor 401 to enable user's microphones and/or cameras at appropriate timeslots to prompt them to participate in the conference. Similarly, prompts may appear on a participant's monitor when it is time for them to speak. By integrating the results into the conferencing system, valuable meeting participation is enhanced.

In certain circumstances such as where the meeting moderator knows that input from a participant who is an expert on a meeting topic and his input is necessary (e.g. in a meeting where high severity issue will be discussed for resolution and one employee is the expert in the area related to the issue), the method allows the moderator to manually adjust the weights of factors used in calculating participation score. This will also affect the allocation time for that individual.

Participants can be given the option to see their own participant score. This may help them find their relevance to the meeting and how much time they should plan to actively participate.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

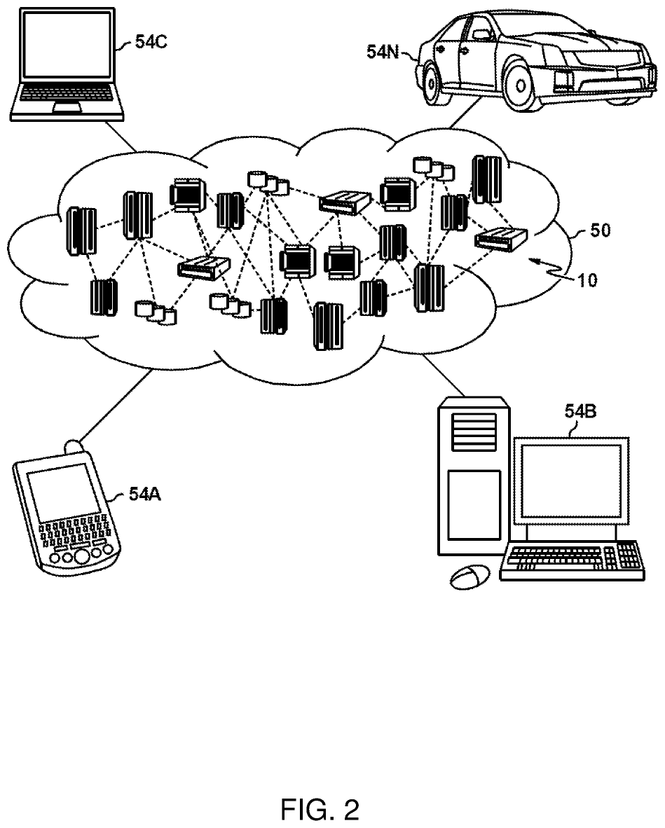

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

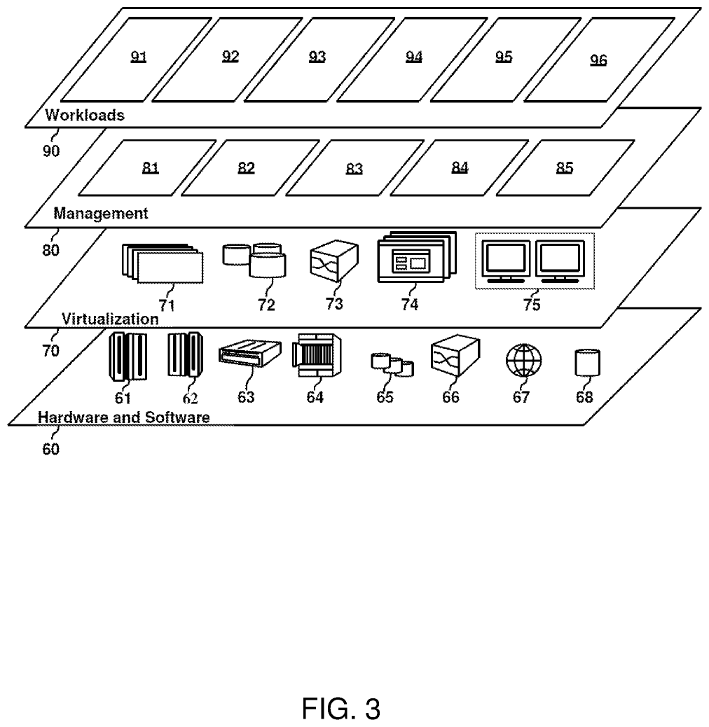

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and participation time allocation 96.

Turning now to FIG. 4, a computer system 400 is generally shown in accordance with an embodiment. The computer system 400 can be an electronic, computer framework comprising and/or employing any number and combination of computing devices and networks utilizing various communication technologies, as described herein. The computer system 400 can be easily scalable, extensible, and modular, with the ability to change to different services or reconfigure some features independently of others. The computer system 400 may be, for example, a server, desktop computer, laptop computer, tablet computer, or smartphone. In some examples, computer system 400 may be a cloud computing node such as a cloud computing node 10 in FIG. 2. Computer system 400 may be described in the general context of computer system executable instructions, such as program modules, being executed by a computer system. Generally, program modules may include routines, programs, objects, components, logic, data structures, and so on that perform particular tasks or implement particular abstract data types. Computer system 400 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, the computer system 400 has one or more central processing units (CPU(s)) 401a, 401b, 401c, etc. (collectively or generically referred to as processor(s) 401). The processors 401 can be a single-core processor, multi-core processor, computing cluster, or any number of other configurations. The processors 401, also referred to as processing circuits, are coupled via a system bus 402 to a system memory 403 and various other components. The system memory 403 can include a read only memory (ROM) 404 and a random access memory (RAM) 405. The ROM 404 is coupled to the system bus 402 and may include a basic input/output system (BIOS), which controls certain basic functions of the computer system 400. The RAM is read-write memory coupled to the system bus 402 for use by the processors 401. The system memory 403 provides temporary memory space for operations of said instructions during operation. The system memory 403 can include random access memory (RAM), read only memory, flash memory, or any other suitable memory systems.

The computer system 400 comprises an input/output (I/O) adapter 406 and a communications adapter 407 coupled to the system bus 402. The I/O adapter 406 may be a small computer system interface (SCSI) adapter that communicates with a hard disk 408 and/or any other similar component. The I/O adapter 406 and the hard disk 408 are collectively referred to herein as a mass storage 410.

Software 411 for execution on the computer system 400 may be stored in the mass storage 410. The mass storage 410 is an example of a tangible storage medium readable by the processors 401, where the software 411 is stored as instructions for execution by the processors 401 to cause the computer system 400 to operate, such as is described herein below with respect to the various Figures. Examples of computer program product and the execution of such instruction is discussed herein in more detail. The communications adapter 407 interconnects the system bus 402 with a network 412, which may be an outside network, enabling the computer system 400 to communicate with other such systems. In one embodiment, a portion of the system memory 403 and the mass storage 410 collectively store an operating system, which may be any appropriate operating system, such as the z/OS or AIX operating system from IBM Corporation, to coordinate the functions of the various components shown in FIG. 4.

Additional input/output devices are shown as connected to the system bus 402 via a display adapter 415 and an interface adapter 416 and. In one embodiment, the adapters 406, 407, 415, and 416 may be connected to one or more I/O buses that are connected to the system bus 402 via an intermediate bus bridge (not shown). A display 419 (e.g., a screen or a display monitor) is connected to the system bus 402 by a display adapter 415, which may include a graphics controller to improve the performance of graphics intensive applications and a video controller. A keyboard 421, a mouse 422, a speaker 423, etc. can be interconnected to the system bus 402 via the interface adapter 416, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 4, the computer system 400 includes processing capability in the form of the processors 401, and, storage capability including the system memory 403 and the mass storage 410, input means such as the keyboard 421 and the mouse 422, and output capability including the speaker 423 and the display 419.

In some embodiments, the communications adapter 407 can transmit data using any suitable interface or protocol, such as the internet small computer system interface, among others. The network 412 may be a cellular network, a radio network, a wide area network (WAN), a local area network (LAN), or the Internet, among others. An external computing device may connect to the computer system 400 through the network 412. In some examples, an external computing device may be an external webserver or a cloud computing node.

It is to be understood that the block diagram of FIG. 4 is not intended to indicate that the computer system 400 is to include all of the components shown in FIG. 4. Rather, the computer system 400 can include any appropriate fewer or additional components not illustrated in FIG. 4 (e.g., additional memory components, embedded controllers, modules, additional network interfaces, etc.). Further, the embodiments described herein with respect to computer system 400 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
profiling, by a processor, a first trait of a first participant and a second trait of a second participant;
determining, by the processor, a first sociability score of the first participant and a second sociability score of the second participant;
profiling, by the processor, a first skill set of the first participant and a second skill set of the second participant;
calculating, by the processor, participation scores of the first participant and the second participant based on the traits, sociability scores, and skill sets of the first participant and the second participant; and
allocating, by the processor, a first portion of time in an online meeting to the first participant and a second portion of time to the second participant based on the respective participation scores of the first participant and the second participant, wherein the first portion of time is reserved for the first participant to contribute to the meeting and the second portion of time is reserved for the second participant to contribute to the meeting.

2. The computer-implemented method of claim 1, wherein the traits are selected from the group consisting of agreeableness, conscientiousness, extraversion, neuroticism, and openness.

3. The computer-implemented method of claim 2, wherein the traits include an aggregated personality score calculated by the processor.

4. The computer-implemented method of claim 1, wherein the sociability scores are based at least in part on the participants' social network activity.

5. The computer-implemented method of claim 1, wherein the participation scores are calculated using inputs that include traits, sociability, and skill sets of the participants.

6. The computer-implemented method of claim 1, further comprising alerting the participants of their turn in an online meeting during their respective allocation of time.

7. The computer-implemented method of claim 1, further comprising activating the participants' microphones during their respective allocation of time.

8. A system comprising:
a memory having computer readable instructions; and
one or more processors for executing the computer readable instructions, the computer readable instructions controlling the one or more processors to perform operations comprising:
profiling a first trait of a first participant and a second trait of a second participant;
determining a first sociability score of the first participant and a second sociability score of the second participant;
profiling a first skill set of the first participant and a second skill set of the second participant;
calculating participation scores of the first participant and the second participant based on the traits, sociability scores, and skill sets of the first participant and the second participant; and
allocating a first potion of time in an online meeting to the first participant and a second portion of time to the second participant based on the respective participation scores of the first participant and the second participant, wherein the first portion of time is reserved for the first participant to contribute to the meeting and the second portion of time is reserved for the second participant to contribute to the meeting.

9. The system of claim 8, wherein the traits are selected from the group consisting of agreeableness, extraversion, conscientiousness, extraversion, neuroticism, and openness.

10. The system of claim 9, wherein the traits are an aggregated personality score.

11. The system of claim 8, wherein the sociability scores are based on the participants' social network activity.

12. The system of claim 8, wherein the participation scores are calculated using inputs of traits, sociability, and skill sets of the participants.

13. The system of claim 8, the computer readable instructions controlling the one or more processors to perform operations comprising alerting the participants of their turn in an online meeting during their respective allocation of time.

14. The system of claim 8, the computer readable instructions controlling the one or more processors to perform operations comprising activating the participants' microphones during their respective allocation of time.

15. A computer program product comprising a computer readable storage medium having program instructions embodied therewith, the program instructions executable by a processor to cause the processor to perform operations comprising:
profiling a first trait of a first participant and a second trait of a second participant;
determining a first sociability score of the first participant and a second sociability score of the second participant;
profiling a first skill set of the first participant and a second skill set of the second participant;
calculating participation scores of the first participant and the second participant based on the traits, sociability scores, and skill sets of the first participant and the second participant; and
allocating a first portion of time in an online meeting to the first participant and a second portion of time to the second participant based on the respective participation scores of the first participant and the second participant, wherein the first portion of time is reserved for the first participant to contribute to the meeting and the second portion of time is reserved for the second participant to contribute to the meeting.

16. The computer program product of claim 15, wherein the traits are an aggregated personality score.

17. The computer program product of claim 15, wherein the sociability scores are based on the participants' social network activity.

18. The computer program product of claim 15, wherein the participation scores are calculated using inputs of traits, sociability, and skill sets of the participants.

19. The computer program product of claim 15, the program instructions executable by a processor to cause the processor to perform operations comprising alerting the participants of their turn in an online meeting during their respective allocation of time.

20. The computer program product of claim 15, the program instructions executable by a processor to cause the processor to perform operations comprising activating the participants' microphones during their respective allocation of time.
